(19) United States
(12) Patent Application Publication
(10) Pub. No.: US 2022/0324136 A1
(43) Pub. Date: Oct. 13, 2022

(54) INLINE EXTRUDATE BOW MEASUREMENT AND CONTROL

(71) Applicant: CORNING INCORPORATED, Corning, NY (US)

(72) Inventors: Joseph Henry Citriniti, Corning, NY (US); Rodney Gene Dunn, Christiansburg, VA (US); David Robert Potts, Newport, VA (US); Paul Edward Washburn, Newport, VA (US)

(21) Appl. No.: 17/608,775

(22) PCT Filed: May 13, 2020
(86) PCT No.: PCT/US2020/032618

§ 371 Date: Nov. 4, 2021

Related U.S. Application Data
(60) Provisional application No. 62/849,376, filed on May 17, 2019.

(51) Int. Cl. B28B 3/26; B28B 17/00

(52) U.S. Cl. CPC B28B 3/269; B28B 17/0081; B28B 3/2672

(57) ABSTRACT

Extrusion techniques for reducing bow of an extrudate formed from a ceramic forming mixture. Velocities of an outer surface of the extrudate are measured at a plurality of peripherally spaced measurement locations. The velocities are compared to determine whether there is a velocity bias, and the comparison is used to selectively alter the flow of the ceramic forming mixture.

### CROSS REFERENCE TO RELATED APPLICATION

This application claims the benefit of priority under 35 U.S.C. § 119 of U.S. Provisional Application No. 62/849,376 filed on May 17, 2019, the content of which is incorporated herein by reference in its entirety.

### BACKGROUND

Honeycomb bodies are used in a variety of applications, such as the construction of particulate filters and catalytic converters that treat unwanted components in a working fluid, such as pollutants in the combustion exhaust of the engine of a vehicle. The process of manufacturing honeycomb bodies generally includes extruding a ceramic forming mixture, such as a ceramic batch material, through an extrusion die to form an extrudate. The extrudate is generally in the form of an elongate log including elongate channels formed between a matrix of intersecting walls. The elongate log may be cut into smaller portions, dried, fired, to form the honeycomb bodies, e.g., used as particulate filters and/or catalytic converter substrates.

### SUMMARY

Various approaches are described herein for, among other things, providing improved systems and methods for controlling bow in an extrudate. For instance, an apparatus to reduce bow of an extrudate can be configured to provide velocity measurements of the outer surface of the extrudate at peripherally spaced locations. The apparatus can be configured use those measurements to alter the flow of the ceramic forming material to reduce bow of the extrudate.

A first example apparatus to reduce bow of an extrudate comprises an extrusion die, a measurement device, a flow control device, and a controller. The extrusion die defines a portion of a flow path of a ceramic forming mixture between an inlet face and a discharge face. The ceramic forming mixture exiting the discharge face forms the extrudate. The measurement device is configured to measure a first velocity of an outer surface of the extrudate at a first location and a second velocity of the outer surface of the extrudate at a second location. The second location is peripherally spaced from the first location. The measurement device is configured to generate first velocity data representative of the first velocity and second velocity data representative of the second velocity. The flow control device is disposed adjacent the flow path of the ceramic forming mixture at a location upstream of the extrusion die. The controller is configured to compare the first velocity data to the second velocity data and to generate a control signal based at least in part on a difference between the first velocity data and the second velocity data being greater than or equal to a predetermined threshold target value.

A second example apparatus to reduce bow of an extrudate comprises an extrusion die, a measurement device, a flow control device, and a controller. The extrusion die defines a portion of a flow path of a ceramic forming mixture between an inlet face and a discharge face. The ceramic forming mixture exiting the discharge face forms the extrudate. The measurement device is configured to measure a first velocity of an outer surface of the extrudate at a first location and a second velocity of the outer surface of the extrudate at a second location. The measurement device is configured to generate first velocity data representative of the first velocity and second velocity data representative of the second velocity. The second location is peripherally spaced from the first location, and the first and second locations are a longitudinal distance from the discharge face of the extrusion die that is less than or equal to 9″. The flow control device is disposed adjacent the flow path of the ceramic forming mixture at a location upstream of the extrusion die. The controller is configured to compare the first velocity data and the second velocity data and to generate a control signal based at least in part on a percentage difference between the first velocity data and the second velocity data being greater than or equal to 1%. The percentage difference is an absolute value of the difference between the first velocity data and the second velocity data divided by an average of the first velocity data and the second velocity data.

An example method for controlling bow of an extrudate comprises forcing a ceramic forming mixture through an extrusion die, measuring a first velocity, measuring a second velocity, comparing the first velocity and the second velocity, and selectively controlling a flow control device. The ceramic forming mixture is forced to flow through an extrusion die to form the extrudate extending along an extrudate flow path. The first velocity of an outer surface of the extrudate is measured at a first location. The second velocity of the outer surface of the extrudate is measured at a second location peripherally spaced from the first location. The first velocity and the second velocity are compared to determine whether a difference between the first velocity and the second velocity is greater than or equal to a predetermined threshold target value. The flow control device is selectively controlled based at least in part on whether the difference between the first velocity and the second velocity is greater than or equal to the predetermined threshold.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a perspective view of an example honeycomb body.

FIG. 2 is a perspective view of a portion of an example extruder including an example of an apparatus to reduce bow of an extrudate in accordance with an embodiment.

FIG. 3 is a top view of the portion of the example extruder shown in FIG. 2 in accordance with an embodiment.

FIGS. 4 and 5 are front views of examples of flow control devices in accordance with embodiments.

FIG. 6 depicts a flowchart of an example method for controlling bow of an extrudate in accordance with an embodiment.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description refers to the accompanying drawings that illustrate example embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the relevant art(s) to implement such feature, structure, or characteristic in connection with other embodiments whether or not explicitly described.

### II. Example Embodiments

Example embodiments described herein provide improvements over known systems for controlling bow of an extrudate formed during extrusion of a ceramic forming mixture. That is, during extrusion, characteristics of the extruder mechanism, extrusion die, and/or ceramic forming mixture rheology may result in variations in size and shape of the extrudate, which can include bow. Bow is generally considered undesirable and may result from flow that biases the extrudate to bend or curve in one or more directions relative to a desired longitudinal extrusion axis. Bow may result in collapsed or misshapen channels, or otherwise cause dimensional variation in the shape and/or size of the final honeycomb body that affects the suitability of the honeycomb body to be installed or used in an exhaust system.

Advantages of the embodiments described herein include an apparatus that allows for real-time, extruder-based bow measurement and control of an extrudate. In an example embodiment, the apparatus is used for direct, closed-loop bow control by including measuring devices that are configured to measure the velocity of the outer surface of the extrudate at a plurality of locations, a flow control device, and a controller that compares the velocities to determine whether there is a velocity bias at peripherally spaced measurement locations around the extrudate. If a velocity bias is determined, the flow control device can be used to alter the flow of the ceramic forming mixture upstream of an extrusion die.

Further advantages of the example embodiments include reducing delay in feedback related to bow of an extrudate. The apparatus provides more sensitive and continuous velocity measurement. The apparatus allows active control over the bow of the extrudate while the extrudate is being extruded.

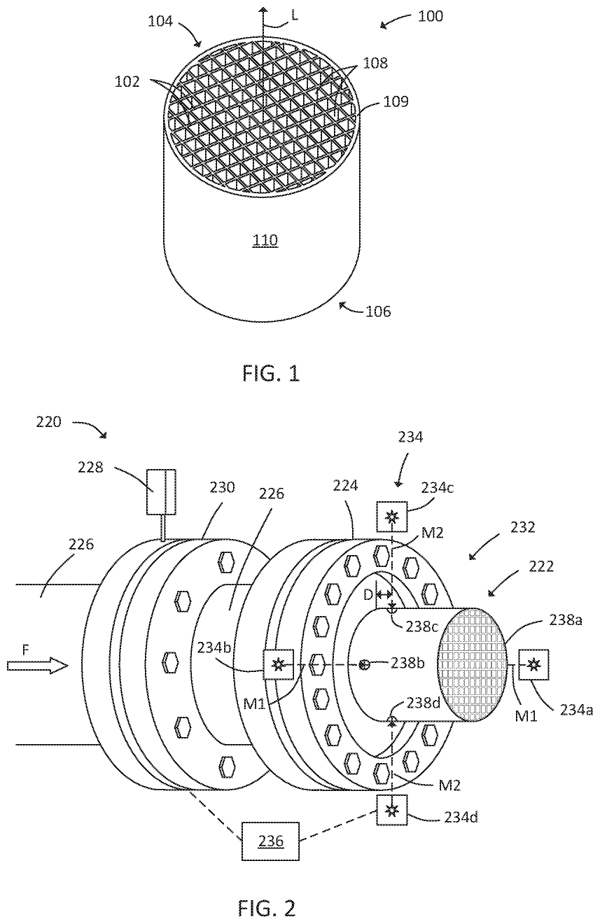

FIG. 1 illustrates an example of a honeycomb body 100. The honeycomb body 100 comprises a plurality of spaced inner walls 102 extending longitudinally through the honeycomb body 100, substantially parallel to a longitudinal axis L. For example, the inner walls 102 extend from a first end 104 to a second end 106 of the honeycomb body 100. The spaced walls 102 have different orientations so that they intersect and combine to define a plurality of channels, or cells 108. The cells 108 form the cellular honeycomb construction of the honeycomb body 100. An outer skin 109 surrounds the inner walls 102 and defines an outer surface 110 of the honeycomb body 100. The outer skin 109 forms and defines the outer shape of the honeycomb body 100.

As used herein, honeycomb body 100 includes a generally honeycomb structure but is not strictly limited to a honeycomb body having channels with a square structure. For example, hexagonal, octagonal, triangular, rectangular or any other suitable channel shape can be used. Also, while the cross section of the honeycomb body 100 is circular, it is not so limited. For example, the cross section can be elliptical, square, rectangular, or any other desired shape.

The honeycomb body 100 can be constructed from porous materials having a predetermined pore size. The honeycomb body 100 is generally formed from an extruded and dried ceramic material. Examples of a ceramic material include but are not limited to cordierite, silicon carbide, silicon nitride, aluminum titanate, alumina and/or mullite, or combinations thereof.

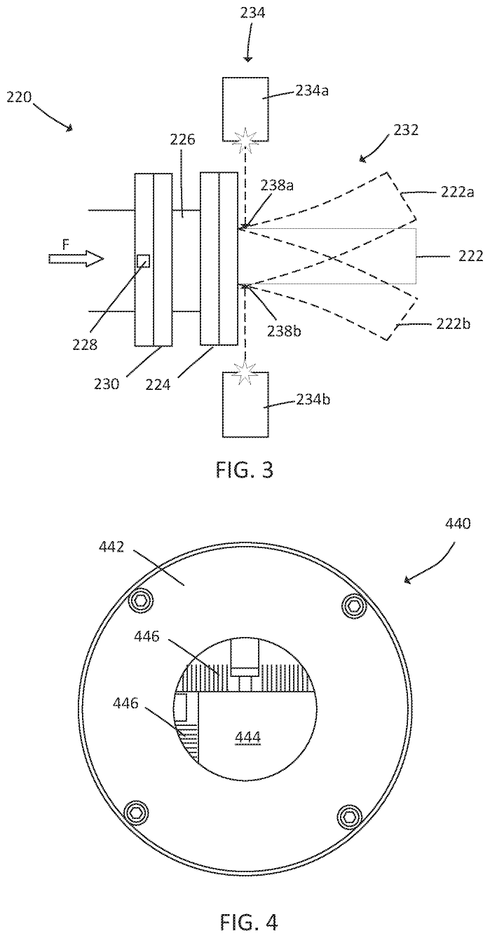

Referring to FIGS. 2 and 3, a portion of an extruder 220, comprising an example apparatus 232 to control, e.g., reduce, bow of an extrudate 222, will be described. As shown in FIG. 3, the extrudate may be bowed. For instance, the extrudate may have a “left” bow 222a (i.e., bow toward the left) or a “right” bow 222b (i.e., bow toward the right). It should be appreciated that the bow may be in any direction, such as downwards, upwards, or at some other angle relative to an intended longitudinal extrusion direction exemplified by extrudate 222 shown in solid lines in FIG. 3. The extruder 220 is used to form extrudate 222 that is processed, such as by cutting, drying, and firing, to form the honeycomb body 100. The extruder 220 generally comprises a feed apparatus that mixes the materials used to form a ceramic forming mixture and that delivers the ceramic forming mixture to an injection apparatus. That is, as used herein, the ceramic forming mixture includes any number of materials that together enable a honeycomb green body to be extruded and then fired to form ceramic honeycomb bodies, e.g., the honeycomb body 100. The ceramic forming mixture can include inorganics (e.g., alumina, silica, etc.), binders (e.g., methylcellulose), a liquid vehicle (e.g., water), sintering aids, and any other ingredients or additives helpful in the manufacturing process of the honeycomb body.

The injection apparatus is used to force a flow F of the ceramic forming mixture toward an extrusion die 224 by pushing, pressurizing and/or plasticizing the ceramic forming mixture. The injection apparatus can provide a continuous extrusion process using a screw extruder, twin-screw extruder, or similar device. Alternatively, the injection apparatus can provide a discontinuous extrusion process using a ram extruder or similar device.

A barrel 226 extends between the injection apparatus and the extrusion die 224 and provides a conduit for the flow of the ceramic forming mixture to the extrusion die 224. Various devices can be coupled to the barrel 226 to monitor and/or control the flow of the ceramic forming mixture to the extrusion die 224. For example, monitoring devices 228 can comprise pressure sensors, temperature sensors, and similar devices. Flow control devices 230 can include a screen/homogenizer, an adjustable flow control device such as a bow deflector device, and/or any other device that can be used to alter the flow characteristics of the ceramic forming mixture.

The apparatus 232 to control the bow of the extrudate comprises the extrusion die 224, a measurement device 234, the flow control device 230, and a controller 236. The extrusion die 224 comprises a die body that defines an inlet face and a discharge face. The die body defines a portion of the flow F of the ceramic forming mixture through the extruder 220 between the inlet face and the discharge face. The extrusion die 224 generally comprises a plurality of feedholes that intersect the inlet face and extend into the die body. The extrusion die 224 also comprises a plurality of pins that extend from the feedholes to the discharge face. The pins are spaced from each other to define intersecting slots. The feedholes are in fluid communication with the slots so that ceramic forming mixture flowing into the feedholes is directed into the slots and then through the discharge face. As the ceramic forming mixture flows out of the discharge face of the extrusion die 224, the ceramic forming mixture forms the extrudate 222. The extrudate 222 flows from the extrusion die 224 along an extrudate flow path and forms an elongate log. The elongate log is subsequently cut or severed manually by an operator or automatically by a cutting device.

The measurement device 234 is configured to measure velocity of an outer surface of the extrudate and to generate velocity data. For example, the measurement device 234 can be configured to measure a plurality of velocities at a plurality of measurement locations on the outer surface of the extrudate that are peripherally spaced around the extrudate 222. In accordance with this example, the measurement device 234 can be configured to generate velocity data corresponding to the plurality of velocities that are measured at the plurality of measurement locations around the extrudate 222.

In an example embodiment, the measurement device 234 comprises a plurality of measurement terminals (e.g., any two or more of measurement terminals 234a, 234b, 234c, 234d) configured to measure velocity at a plurality of peripherally spaced locations that are distributed circumferentially around the extrudate 222. For example, the measurement device 234 comprises a first measurement terminal 234a and a second measurement terminal 234b. The first measurement terminal 234a is configured to measure a first velocity of an outer surface of the extrudate 222 measured at a first location 238a and to generate first velocity data. The second measurement terminal 234b is configured to measure a second velocity of the outer surface of the extrudate 222 measured at a second location 238b and to generate second velocity data. The first location 238a and the second location 238b are peripherally spaced from each other. For instance, the first and second locations 238a, 238b can be peripherally spaced by an angle that is between about 10° and about 180°. In an aspect, the first and second locations 238a, 238b can be spaced by an angle between about 45° and about 180°. In accordance with the illustrated example, the first location 238a and the second location 238b are peripherally opposed, that is, they are oppositely opposed on the outer surface of the extrudate 222, or disposed on laterally opposite sides of the extrudate 222, i.e., so that they are spaced by an angle of about 180° with respect to a center axis of the extrudate 222.

The first location 238a and the second location 238b define a first monitor axis M1 extending between the first location 238a and the second location 238b that extends through the extrudate 222 substantially perpendicular to the extrudate flow path. In an aspect, the extrudate can have a generally cylindrical shape and the peripherally opposed first and second locations are oriented so that they are on diametrically opposite sides of the extrudate 222.

In accordance with the example mentioned above, the measurement device 234 can further comprise a third measurement terminal 234c. The third measurement terminal 234c is configured to measure a third velocity of the outer surface of the extrudate 222 measured at a third location 238c and to generate third velocity data. In further accordance with this example, the measurement device 234 can comprise a fourth measurement terminal 234d. The fourth measurement terminal 234d is configured to measure a fourth velocity of the outer surface of the extrudate 222 measured at a fourth location 238d and to generate fourth velocity data. In an example implementation that comprises both the third measurement terminal 234c and the fourth measurement terminal 234d, the third location 238c and the fourth location 238d are peripherally spaced from each other. For instance, the third location 238c and the fourth location 238d are peripherally opposed. The third location 238c and the fourth location 238d define a second monitor axis M2 extending therebetween, that generally extends through the extrudate 222 perpendicular to the extrudate flow path. In accordance with this implementation, the measurement locations 238 are located so that an angle between the first monitor axis M1 and the second monitor axis M2 is in a range between about 10° and about 90°. For instance, the first monitor axis M1 and the second monitor axis M2 can be angled relative to each other so that they are approximately perpendicular, as shown in FIG. 2. It should be appreciated that a line of sight of the measurement terminals 234a, 234b, 234c, 234d can be normal, or angled, relative to the outer surface of the extrudate.

It is to be appreciated that (e.g., even without moving the position of the measurement locations 238 relative to the extrudate 222) the measurement devices 234 (e.g., the terminals 234a-d) can lie on the monitor axes (e.g., M1 and M2), or be positioned at an angle with respect to the monitor axes. In other words, the measurement devices 234 can be arranged to monitor the surface of the extrudate 222 at an angle as opposed to being arranged at the normal with respect to the surface of the extrudate 222.

In an example, multiple measurement terminals can be directed to measurement locations on the extrudate 222 in relatively close proximity. In such an example, the velocity measurements can be averaged, which can improve accuracy and repeatability. In an aspect, the measurement locations for the averaged velocity measurements can be disposed within an area of the outer surface of the extrudate 222 that is less than or equal to 0.50 in² (about 323 mm²), and in another aspect less than or equal to 0.25 in² (about 161 mm²).

During production of the extrudate, bow can form along any axis, and the measurement device 234 can be configured to generate velocity data related to any axis. In the example embodiment of FIG. 2, the measurement locations 238 can be generally described as being peripherally spaced at 90° intervals, e.g., at 0°, 90°, 180°, and 270° positions about the extrudate 222. In another example embodiment, the measurement locations 238 are peripherally spaced at 45°, 135°, 225°, and 315° positions about the extrudate 222. In an example embodiment, the measured velocities are resolved to any axis using regression techniques, so that the measurement device 234 need not necessarily be configured to directly measure velocity at opposed locations around the extrudate 222. In an example embodiment, the measurement locations 238 are oriented based on empirical data indicating a predominant bow direction. In another example embodiment, the measurement locations 238 are oriented to accommodate physical restrictions of adjacent hardware.

The measurement device 234 can be configured as a non-contact velocity measurement device, where there is no direct contact between the extrudate 222 and the measurement device 234. Alternatively, the measurement device 234 can be configured as a contact velocity measurement device that is in direct contact with the extrudate 222.

In an example embodiment, the non-contact velocity measurement device is a laser velocimeter, such as a laser Doppler velocimeter. In an aspect of this embodiment, measurement terminals 234a, 234b, 234c, 234d of the measurement device 234 can be arranged so that the measurement locations are peripherally spaced by 90° increments around the extrudate 222. That configuration allows the measurement of velocity of the outer surface on opposite sides of extrudate 222, which can be used to calculate a velocity bias across the extrudate 222 in two axes, which can be further resolved to velocity bias in any axis. The measurement device 234 can use the texture (e.g., bumps, grooves, roughness, or other micro-imperfections) of the outer surface of the extrudate 222 to assist in detecting the velocity of the extrudate 222 as the extrudate 222 flows out of the extrusion die 224.

In some embodiments, the measurement devices 234 are configured to measure the velocity of the extrudate 222 in a direction generally parallel to the extrudate flow path. The measurement devices can be oriented so that a line of sight of the laser is oriented normal to the outer surface of the extrudate 222 at the measurement location 238 to reduce off-axis measurement error, however, other angles relative to the normal can be used.

Laser velocimeters provide a variety of advantages over other types of measurement devices such as by providing high-precision, non-contact measurement. Additionally, laser velocimeters can be relatively small, as compared to other types of measurement devices. The small size allows the laser velocimeters to be positioned close to the discharge face of the extrusion die 224 and optimally oriented relative to the outer surface of the extrudate 222. The small size can also allow a relatively high number of laser velocimeters to be disposed around the extrudate 222 in close proximity to the discharge face. In an example, the measurement devices 234 can be Polytec LSV-1000 Laser Surface Velocimeters. It should be appreciated that velocity measurement devices other than laser velocimeters can be used. Additionally, combinations of different types of velocity measurement devices can be used simultaneously.

In another example embodiment, the non-contact velocity measurement device can utilize digital image correlation to generate velocity data. As an example, the measurement device 234 can comprise a digital camera configured to capture a series of images of one or more marks, or texture (e.g., micro-imperfection), on the outer surface of the extrudate 222 over a period of time. For example, one or more marks can be applied on the outer surface of the extrudate 222 such as by a print head that applies ink, such as squid ink, to the outer surface. Alternatively, the camera can identify and track one or more distinguishing textural features, e.g., a bump, gouge, groove, etc. In combination with a timer, the captured series of images can be used to generate the velocity data as the mark or identified feature moves in each image. It should be appreciated that the digital camera can be constructed as a small fiber optic camera so that images can be captured in close proximity to the discharge face of the extrusion die 224. The apparatus 232 can also comprise a light source to improve the images captured by the digital camera. In example implementations of a measurement device 234 utilizing a digital camera, the line of sight of the digital camera can but need not necessarily be normal to the outer surface of the extrudate 222.

As mentioned above, the measurement devices 234 can be configured as a contact velocity measurement device. As an example, the contact velocity measurement device can be a Surveyor's wheel or a waywiser that measures travel distance of the extrudate 222 over time. The measurement of travel distance of the extrudate 222 over time can be used to generate velocity data.

The measurement locations 238 can be located so that the measurement locations 238 are disposed within a predefined distance D from the discharge face of the extrusion die 224. In an example embodiment, the measurement locations 238, such as first location 238a and second location 238b, are a longitudinal distance D from the discharge face of the extrusion die 224 that is less than or equal to 9 inches (about 239 mm). In an implementation of this embodiment, the measurement locations 238 are a longitudinal distance D from the discharge face of the extrusion die 224 that is less than or equal to 3 inches (about 76 mm). In another example embodiment, the measurement locations 238 are a longitudinal distance D from the discharge face of the extrusion die 224 that is related to a maximum cross-sectional width dimension of the extrudate 222 (e.g., a diameter of the circular extrudate, a diagonal of a rectangular extrudate, etc.) measured laterally across the extrudate 222. For example, the measurement locations 238 can be a longitudinal distance D from the discharge face of the extrusion die 224 that is less than or equal to the maximum cross-sectional width dimension of the extrudate 222. Additionally, a size of the measurement location 238 can be selected to provide sufficient surface area for the respective measurement device.

The flow control device 230 of the apparatus 232 is disposed adjacent the flow path of the ceramic forming mixture through the extruder 220. The flow control device 230 is disposed upstream of the extrusion die 224, i.e., so that the flow control device 230 is interposed between the feed apparatus of the extruder 220 and the extrusion die 224. The location of the flow control device 230 allows the flow control device 230 to manipulate the flow of the ceramic forming mixture upstream from the extrusion die 224. The manipulation of the flow of the ceramic forming mixture allows the apparatus to alter the amount of bow of the extrudate 222. In an example embodiment, the flow control device 230 is configured to disturb a portion of the flow of the ceramic forming mixture (e.g., to physically block or impede a portion of the flow). In another example embodiment, the flow control device 230 is configured to alter at least one physical characteristic of the ceramic forming mixture (e.g., to increase or decrease temperature or extrusion pressure, to increase or decrease viscosity or other rheological properties by increasing or decreasing an amount of water or other substances added to the ceramic forming mixture, etc.). The apparatus 232 can comprise multiple stages of flow control devices 230, and the flow control devices can be configured to disturb a portion of the flow of the ceramic mixture, to alter at least one physical characteristic of the ceramic forming mixture, or both.

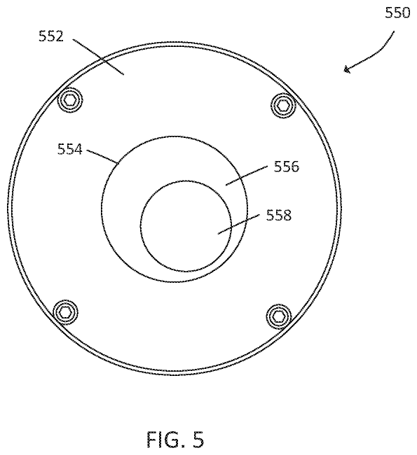

In an example embodiment, the flow control device 230 comprises a mechanism that is configured to disturb at least a portion of the flow of ceramic forming mixture through the extruder 220. The mechanism can disturb at least a portion of the flow of ceramic forming mixture by placing an impediment in a portion of the flow of ceramic forming mixture. Examples of flow control devices that can be used for flow control device 230 are illustrated in FIGS. 4 and 5 in accordance with example embodiments. Referring first to FIG. 4, a flow control device 440 comprises a base 442 that defines an aperture 444 and a plurality of adjustable plates 446 movably mounted to the base 442. The adjustable plates 446 are movable so that they are configured to selectively extend across a portion the aperture 444. In the extruder 220, the flow of ceramic forming mixture is directed through the aperture 444 and the adjustable plates 446 can be moved so that they disturb the flow of the ceramic forming mixture to correct bow of the extrudate 222. Any number of adjustable plates 446 can be included to provide different amounts and resolution of control over the disturbance of the flow of the ceramic forming mixture that can be used to alter extrudate bow.

Referring to FIG. 5, a flow control device 550 comprises a base 552 that defines a first aperture 554. A bow plate 556 extends over at least a portion of the first aperture 554. The blow plate 556 is movably mounted to the base 552 and defines a second aperture 558. The bow plate 556 is movable so that the first aperture 554 and the second aperture 558 can be positioned relative to each other to control bow of the extrudate 222. Examples of flow control devices, and additional details of their construction, that can be used in apparatus 232 are provided in U.S. Pat. No. 9,393,716, issued Jul. 19, 2016, and PCT Publication No. WO 2017/087753, published May 26, 2017, which are hereby incorporated by reference in their entireties.

The physical characteristics of the ceramic forming mixture can be altered to manipulate the flow of the material. For example, the temperature of the ceramic forming mixture can be altered, which can change the viscosity and resulting flow of the ceramic forming mixture. For example, portions of the flow of ceramic forming mixture can be heated or cooled throughout the extruder 220 to manipulate the flow and to alter bow of the extrudate 222. As an example, thermal imbalances in the extruder 220 can be generated to counteract viscosity differences in the ceramic forming mixture, which can be used to correct rheology induced bow. Such a change in temperature can be created using heating elements such as resistive heaters, cooling elements such as coolant circuits, and/or by altering the operation of another portion of the extruder 220, such as by altering the RPM of the screws or force of the ram, which can also result in a temperature change.

The flow control device 230 can be adjusted automatically or manually. For example, the flow control device 230 can be adjusted using externally mounted servo motors coupled to the flow control device 230. In an example embodiment, a motor can be coupled to one or more adjustable plates, such as the adjustable plates 446 of FIG. 4, included in the flow control device 230. In another example embodiment, a motor can be coupled to an adjustable bow plate, such as bow plate 556 shown in FIG. 5, included in the flow control device 230. Manual adjustments to the flow control device 230 can be made by an operator, such as by altering the position of a manually movable adjustable plate 446 or bow plate 556.

The controller 236 of apparatus 232 is configured to compare velocity data from the measurement locations 238 around the extrudate. The controller 236 can be constructed as a multi-input, multi-output controller. As the measurement devices 234 measure the velocity of the outer surface of the extrudate 222 and generate velocity data representative of the velocity, the velocity data is communicated to the controller 236. The controller 236 compares the velocity data from the various measurement locations to determine whether there is a difference between velocities of the outer surface measured at peripherally spaced locations around the extrudate 222. In an example embodiment, the velocity is measured at peripherally opposed locations on the outer surface of the extrudate 222, and the velocities are compared. In another embodiment, a plurality of velocities are measured at peripherally spaced locations around the extrudate 222, and the controller 236 resolves the velocities to determine whether there is a velocity difference at peripherally opposed locations around the extrudate 222.

The controller 236 is configured to generate a control signal based at least in part on a magnitude of a difference between the first velocity data and the second velocity data being greater than or equal to a predetermined threshold for velocity bias. The magnitude of the difference between the first velocity data and the second velocity data can be determined by calculating the absolute value of the difference between the first velocity data and the second velocity data. In an example embodiment, the predetermined threshold is a percentage of an average magnitude of the first velocity data and the second velocity data. In an example embodiment, the controller can be configured to generate a control signal based at least in part on a magnitude of the difference between the first velocity data and the second velocity data being greater than a predetermined threshold. In an example embodiment, the first measurement location 238a and the second measurement location 238b are peripherally opposed, and the predetermined threshold is a percentage of an average of the first velocity data and the second velocity data. For example, the predetermined threshold can be 1% of the average magnitude of the first velocity data and the second velocity data. In another example, the predetermined threshold can be 2% of the average magnitude of the first velocity data and the second velocity data. In yet another example, the predetermined threshold can be 3% of the average magnitude of the first velocity data and the second velocity data.

The difference between the first velocity data and the second velocity data can be used to indicate the direction of bow of the extrudate 222 and can be used to generate the control signal. For example, when considering peripherally opposite measurement locations, the extrudate 222 will generally bow toward the location having the lower velocity, and that determination can be used to generate the control signal. When calculating the difference between the first velocity data (V1) and the second velocity data (V2), the sign of the difference can be used to generate the control signal (i.e., whether V1−V2 is positive or negative) that indicates a direction to control the bow. It will be recognized that the controller 236 can be coupled to the flow control device 230. For instance, the controller 236 can be in electrical communication with the flow control device 230.

The control signal generated by the controller 236 can be used to provide feedback for adjusting the flow control device 230. In an example embodiment, the control signal is configured as a command sent to the flow control device 230 to alter the flow of the ceramic forming mixture. In an implementation of this embodiment, the flow control device 230 is configured with an attached motor, and the command is configured to drive the attached motor automatically. Accordingly, a closed feedback loop can be created by the apparatus 232. In another example embodiment, the control signal is configured to provide instructions for creating a display that provides visual feedback, such as a visual indicator or indicium, to an operator. The operator can use the information presented by the visual feedback to manually adjust the flow control device 230 to alter the flow of the ceramic forming mixture.

A test apparatus was constructed and used to collect empirical data, shown in Table 1, and to validate the operation of the apparatus 232. The test apparatus was constructed using a pair of peripherally opposed commercial laser velocimeters. The laser velocimeters were installed adjacent a 40 mm extruder and positioned at approximately 0° and 180° positions such as the first measurement device 234a and the second measurement device 234b shown in FIG. 2. As a result, the laser velocimeters were configured to measure the velocity of the outer surface of the extrudate at peripherally opposed measurement locations, such as the first measurement location 238a and the second measurement location 238b shown in FIG. 2. The laser velocimeters were leveled and oriented so that a line of sight of the laser in each laser velocimeter was oriented approximately normal to the outer surface of the extrudate exiting the extrusion die. A flow control device upstream from the extrusion die was employed to form the extrudate so that the extrudate demonstrated a bow in a selected orientation that was generally in a horizontal plane including the measurement locations (i.e., “left” or “right” bow was intentionally introduced). The velocities were measured at the measurement locations using the laser velocimeters, and velocity data representative of the measured velocities was generated and analyzed. The velocity data confirmed that an extrudate demonstrating bow does display a velocity bias of the outer surface of the extrudate measured at peripherally spaced measurement locations.

TABLE 1

| | | Mean Left | Mean Right | | Mean |
|---|---|---|---|---|---|
| | | Velocity | Velocity | Velocity | Velocity |
| | Observed | (VL) | (VR) | Bias | Bias |
| Test | Bow | [m/min)] | [m/min) | (VL-VR) | (% of Mean) |
| 1 | No bow | 0.781 | 0.782 | −0.001 | −0.001 |
| | | | | | (0.1%) |
| 2 | Right | 0.823 | 0.759 | 0.064 | 0.041 |
| 3 | Right | 0.739 | 0.715 | 0.023 | (5.1%) |
| 4 | Right | 0.813 | 0.776 | 0.037 | |
| 5 | Left | 0.776 | 0.814 | −0.036 | −0.029 |
| 6 | Left | 0.793 | 0.813 | −0.020 | (3.7%) |
| 7 | Left | 0.782 | 0.813 | −0.032 | |

While manually introducing bow in the extrudate, a mean right velocity and a mean left velocity were measured. The velocity bias (VL−VR) was calculated for each test condition. The no-bow condition of test 1, such as that illustrated by extrudate 222 in FIG. 3, demonstrated a mean velocity bias that was measured to be −0.001 m/min, or 0.1%. The right bow condition of tests 2-4, such as that illustrated by extrudate 222b of FIG. 3, demonstrated a mean velocity bias of approximately 0.041 m/min, or 5.1%, with VL greater than VR. The left bow condition of tests 5-7, such as that illustrated by extrudate 222a of FIG. 3, demonstrated a mean velocity bias of approximately −0.029 m/min, or 3.7%, with VR greater than VL. The measurement resolution was analyzed, and the measurement was determined to have sufficient resolution and stability to properly resolve the bias between the left and right velocities in the no-bow, the left bow, and the right bow conditions.

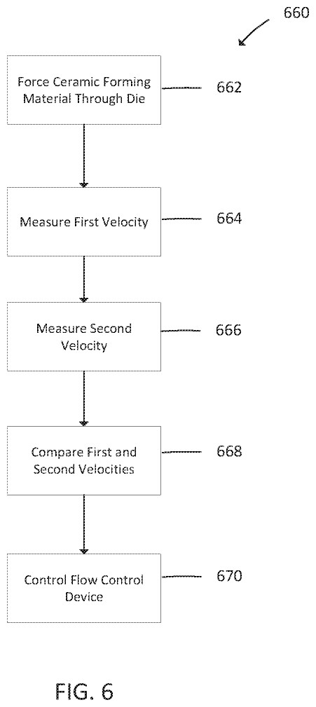

FIG. 6 depicts a flowchart 660 of an example method for controlling bow of an extrudate. Flowchart 660 can be performed using any of the embodiments of the apparatus 232 for controlling bow shown in FIGS. 2 and 3, for example. Further structural and operational embodiments will be apparent to persons skilled in the relevant art(s) based on the discussion regarding the flowchart 660.

As shown in FIG. 6, the method of flowchart 660 begins at step 662. In step 662, the ceramic forming mixture is forced through an extrusion die. In an example embodiment, forcing the ceramic forming mixture at step 662 comprises forcing the ceramic forming mixture to flow through the extrusion die to form the extrudate. The extrudate flowing out of the extrusion die extends along an extrudate flow path. As an example, the ceramic forming mixture can be forced by an extruder through the extrusion die (e.g., forced by extruder 220 through extrusion die 224).

At step 664, a first velocity is measured. Measuring the first velocity at step 664 comprises measuring the first velocity of an outer surface of the extrudate 222 at a first location. In an example embodiment, the first velocity is measured by a measurement device 234a at a first location 238a on the outer surface of the extrudate 222.

At step 666, a second velocity is measured. Measuring the second velocity at step 666 comprises measuring the second velocity of an outer surface of the extrudate 222 at a second location that is peripherally spaced from the first location. In an example embodiment, the first location and the second location are peripherally opposed. For example, the second velocity is measured by a measurement device 234b at a second location 238b on the outer surface of the extrudate 222 that is peripherally spaced so that the second location 238b is peripherally opposed to the first location 238a.

At step 668, the first and second velocities are compared. Comparing the first velocity data and the second velocity data at step 668 comprises determining whether a magnitude of a difference between the first velocity data and the second velocity data is greater than or equal to a predetermined threshold. In an example embodiment, the predetermined threshold is 1% of an average magnitude of the first velocity data and the second velocity data. In an example implementation, comparing the first velocity data and the second velocity data can be performed by the controller 236 of apparatus 232 or by an operator.

In an example embodiment, third and fourth velocities are measured. The third and fourth velocities are measured at third and fourth locations, and velocity data representative of the third and fourth velocities are compared. The third and fourth velocities can be compared to determine whether a magnitude of a difference between the third velocity data and the fourth velocity data is greater than or equal to a second predetermined threshold. In an example embodiment, the third and fourth measurement locations are peripherally opposed.

At step 670, a flow control device is selectively controlled. Selectively controlling the flow control device in step 670 is based at least in part on whether the magnitude of the difference between the first velocity data and the second velocity data is greater than or equal to the predetermined threshold. In an example embodiment, selectively controlling the flow control device comprises moving at least a portion of the flow control device so that the flow control device at least partially disturbs the flow of the ceramic forming mixture upstream from the extrusion die. For example, the flow control device, such as flow control devices 440, 550 of FIGS. 4 and 5 respectively, c be selectively controlled by controller 236 of apparatus 232 or by an operator.

### III. Further Discussion of Some Example Embodiments

In one aspect, an apparatus to reduce bow of an extrudate is provided. The apparatus comprises an extrusion die defining a portion of a flow path of a ceramic forming mixture between an inlet face and a discharge face, wherein the ceramic forming mixture exiting the discharge face forms the extrudate; a measurement device configured to measure a first velocity of an outer surface of the extrudate at a first location and a second velocity of the outer surface of the extrudate at a second location peripherally spaced from the first location and to generate first velocity data representative of the first velocity and second velocity data representative of the second velocity; a flow control device disposed along the flow path of the ceramic forming mixture at a location upstream of the extrusion die, the flow control device controllable by control signals; and a controller configured to compare the first velocity data to the second velocity data, to generate a control signal based at least in part on a magnitude of a difference between the first velocity data and the second velocity data being greater than or equal to a predetermined threshold, and to communicate the control signal to the flow control device.

In some embodiments, the first and second locations are a longitudinal distance from the discharge face of the extrusion die that is less than or equal to 9 inches (22.86 cm).

In some embodiments, the first and second locations are a longitudinal distance from the discharge face of the extrusion die that is less than or equal to 3 inches (7.62 cm).

In some embodiments, the extrudate has a maximum cross-sectional width dimension measured laterally across the extrudate, and wherein the first and second locations are a longitudinal distance from the discharge face of the extrusion die that is less than or equal to the maximum cross-sectional width dimension.

In some embodiments, the controller is coupled to the flow control device so that the controller is in electronic communication with the flow control device.

In some embodiments, at least a portion of the flow control device is movable into a configuration in which the flow control device is at least partially disposed in the flow path to at least partially block the flow of the ceramic forming mixture based at least in part on the control signal.

In some embodiments, the apparatus further comprises a display that is configured to provide at least one visual indicium based at least in part on the control signal.

In some embodiments, the measurement device comprises a non-contact velocity measurement device that is configured to be spaced from the extrudate during measurement of the first velocity and the second velocity of the outer surface of the extrudate.

In some embodiments, the non-contact velocity measurement device comprises a laser velocimeter that is directed toward the outer surface of the extrudate and normal to the outer surface of the extrudate.

In some embodiments, the non-contact velocity measurement device comprises a digital camera configured to collect a series of images of the outer surface of the extrudate over a period of time.

In some embodiments, the measurement device comprises a contact velocity measurement device.

In some embodiments, the first location and the second location are oppositely opposed on the outer surface.

In some embodiments, the measurement device is configured to measure a third velocity of the outer surface of the extrudate at a third location and a fourth velocity of the outer surface of the extrudate at a fourth location peripherally spaced from the third location and to generate third velocity data representative of the third velocity and fourth velocity data representative of the fourth velocity.

In some embodiments, the third location and the fourth location are oppositely opposed on the outer surface.

In some embodiments, the first location and the second location define a first monitor axis extending between the first location and the second location, wherein the first monitor axis extends through the extrudate substantially perpendicular to the extrudate flow path, wherein the third location and the fourth location define a second monitor axis extending between the third location and the fourth location, and wherein the second monitor axis extends through the extrudate substantially perpendicular to the extrudate flow path, and wherein the second monitor axis is angled relative to the first monitor axis in a range between 10° and 90°.

In some embodiments, the predetermined threshold is 1% of an average magnitude of the first velocity data and the second velocity data.

In another aspect, an apparatus to reduce bow of an extrudate is provided. The apparatus comprises an extrusion die defining a portion of a flow path of a ceramic forming mixture between an inlet face and a discharge face, wherein the ceramic forming mixture exiting the discharge face forms the extrudate; a measurement device configured to measure a first velocity of an outer surface of the extrudate at a first location and a second velocity of the outer surface of the extrudate at a second location peripherally spaced from the first location and to generate first velocity data representative of the first velocity and second velocity data representative of the second velocity, wherein the first and second locations are a longitudinal distance from the discharge face of the extrusion die that is less than or equal to a maximum cross-sectional dimension of the extrudate; a flow control device disposed adjacent the flow path of the ceramic forming mixture at a location upstream of the extrusion die, the flow control device controllable by control signals; and a controller configured to compare the first velocity data and the second velocity data, to generate a control signal based at least in part on a percentage difference between the first velocity data and the second velocity data being greater than or equal to 1%, and to communicate the control signal to the flow control device, wherein the percentage difference is an absolute value of a difference between the first velocity data and the second velocity data divided by an average of the first velocity data and the second velocity data.

In some embodiments, the controller is coupled to the flow control device so that the controller is in electronic communication with the flow control device.

In some embodiments, the first location and the second location are oppositely opposed on the outer surface.

In some embodiments, the measurement device is configured to measure a third velocity of the outer surface of the extrudate at a third location and a fourth velocity of the outer surface of the extrudate at a fourth location peripherally spaced from the third location and to generate third velocity data representative of the third velocity and fourth velocity data representative of the fourth velocity.

In some embodiments, the third location and the fourth location are oppositely opposed on the outer surface.

In some embodiments, the first location and the second location define a first monitor axis extending between the first location and the second location, wherein the first monitor axis extends through the extrudate substantially perpendicular to the extrudate flow path, wherein the third location and the fourth location define a second monitor axis extending between the third location and the fourth location, and wherein the second monitor axis extends through the extrudate substantially perpendicular to the extrudate flow path, and wherein the second monitor axis is angled relative to the first monitor axis in a range between 10° and 90°.

In another aspect, a method for controlling bow of an extrudate is provided. The method comprises forcing a ceramic forming mixture to flow through an extrusion die to form the extrudate extending along an extrudate flow path; and controlling a flow control device based at least in part on whether a magnitude of a difference between a first velocity of an outer surface of the extrudate at a first location proximate to a discharge face of the extrusion die and a second velocity of the outer surface of the extrudate at a second location proximate to the discharge face of the extrusion die and peripherally spaced from the first location is greater than or equal to a predetermined threshold target value.

In some embodiments, the predetermined threshold target value is 1% of an average magnitude of the first velocity and the second velocity.

In some embodiments, the method further comprises disturbing the flow of the ceramic forming mixture upstream of the extrusion die based at least in part on the magnitude of the difference between the first velocity and the second velocity being greater than or equal to the predetermined threshold target value.

In some embodiments, the first location and the second location are oppositely opposed on the outer surface.

In some embodiments, the method further comprises measuring a third velocity of the outer surface of the extrudate at a third location; measuring a fourth velocity of the outer surface of the extrudate at a fourth location peripherally spaced from the third location; comparing the third velocity and the fourth velocity to determine whether a magnitude of a difference between the third velocity and the fourth velocity is greater than or equal to a second predetermined threshold target value; and selectively controlling the flow control device based at least in part on whether the magnitude of the difference between the third velocity and the fourth velocity is greater than or equal to the second predetermined threshold target value.

In some embodiments, the third location and the fourth location are oppositely opposed on the outer surface.

In some embodiments, at least one of measuring the first velocity or measuring the second velocity comprises measuring the velocity of the outer surface of the extrudate with a laser velocimeter.

In some embodiments, at least one of measuring the first velocity or measuring the second velocity comprises collecting a series of images and tracking a position of one or more features of the outer surface of the extrudate in the series of images over a period of time.

### IV. Conclusion

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims, and other equivalent features and acts are intended to be within the scope of the claims.

1. An apparatus to reduce bow of an extrudate, the apparatus comprising:
an extrusion die defining a portion of a flow path of a ceramic forming mixture between an inlet face and a discharge face, wherein the ceramic forming mixture exiting the discharge face forms the extrudate;
a measurement device configured to measure a first velocity of an outer surface of the extrudate at a first location and a second velocity of the outer surface of the extrudate at a second location peripherally spaced from the first location and to generate first velocity data representative of the first velocity and second velocity data representative of the second velocity;
a flow control device disposed along the flow path of the ceramic forming mixture at a location upstream of the extrusion die, the flow control device controllable by control signals; and
a controller configured to compare the first velocity data to the second velocity data, to generate a control signal based at least in part on a magnitude of a difference between the first velocity data and the second velocity data being greater than or equal to a predetermined threshold, and to communicate the control signal to the flow control device.

2. The apparatus of claim 1, wherein the first and second locations are a longitudinal distance from the discharge face of the extrusion die that is less than or equal to 9 inches (22.86 cm).

3. The apparatus of claim 2, wherein the first and second locations are a longitudinal distance from the discharge face of the extrusion die that is less than or equal to 3 inches (7.62 cm).

4. The apparatus of claim 1, wherein the extrudate has a maximum cross-sectional width dimension measured laterally across the extrudate, and wherein the first and second locations are a longitudinal distance from the discharge face of the extrusion die that is less than or equal to the maximum cross-sectional width dimension.

5. The apparatus of claim 1, wherein the controller is coupled to the flow control device so that the controller is in electronic communication with the flow control device.

6. The apparatus of claim 5, wherein at least a portion of the flow control device is movable into a configuration in which the flow control device is at least partially disposed in the flow path to at least partially block the flow of the ceramic forming mixture based at least in part on the control signal.

7. The apparatus of claim 1, further comprising a display that is configured to provide at least one visual indicium based at least in part on the control signal.

8. The apparatus of claim 1, wherein the measurement device comprises a non-contact velocity measurement device that is configured to be spaced from the extrudate during measurement of the first velocity and the second velocity of the outer surface of the extrudate.

9. The apparatus of claim 8, wherein the non-contact velocity measurement device comprises a laser velocimeter that is directed toward the outer surface of the extrudate and normal to the outer surface of the extrudate.

10. The apparatus of claim 8, wherein the non-contact velocity measurement device comprises a digital camera configured to collect a series of images of the outer surface of the extrudate over a period of time.

11. The apparatus of claim 1, wherein the measurement device comprises a contact velocity measurement device.

12. The apparatus of claim 1, wherein the first location and the second location are oppositely opposed on the outer surface of the extrudate.

13. The apparatus of claim 1, wherein the measurement device is configured to measure a third velocity of the outer surface of the extrudate at a third location and a fourth velocity of the outer surface of the extrudate at a fourth location peripherally spaced from the third location and to generate third velocity data representative of the third velocity and fourth velocity data representative of the fourth velocity.

14. The apparatus of claim 13, wherein the third location and the fourth location are oppositely opposed on the outer surface of the extrudate.

15. The apparatus of claim 13, wherein the first location and the second location define a first monitor axis extending between the first location and the second location, wherein the first monitor axis extends through the extrudate substantially perpendicular to the extrudate flow path, wherein the third location and the fourth location define a second monitor axis extending between the third location and the fourth location, and wherein the second monitor axis extends through the extrudate substantially perpendicular to the extrudate flow path, and wherein the second monitor axis is angled relative to the first monitor axis in a range between 10° and 90°.

16. The apparatus of claim 1, wherein the predetermined threshold is 1% of an average magnitude of the first velocity data and the second velocity data.

17-22. (canceled)

23. A method for controlling bow of an extrudate, comprising:
forcing a ceramic forming mixture to flow through an extrusion die to form the extrudate extending along an extrudate flow path; and
controlling a flow control device based at least in part on whether a magnitude of a difference between a first velocity of an outer surface of the extrudate at a first location proximate to a discharge face of the extrusion die and a second velocity of the outer surface of the extrudate at a second location proximate to the discharge face of the extrusion die and peripherally spaced from the first location is greater than or equal to a predetermined threshold target value.

24. The method of claim 23, wherein the predetermined threshold target value is 1% of an average magnitude of the first velocity and the second velocity.

25. The method of claim 1, further comprising disturbing the flow of the ceramic forming mixture upstream of the extrusion die based at least in part on the magnitude of the difference between the first velocity and the second velocity being greater than or equal to the predetermined threshold target value.

26. (canceled)

27. The method of claim 1, comprising:
measuring a third velocity of the outer surface of the extrudate at a third location;
measuring a fourth velocity of the outer surface of the extrudate at a fourth location peripherally spaced from the third location;
comparing the third velocity and the fourth velocity to determine whether a magnitude of a difference between the third velocity and the fourth velocity is greater than or equal to a second predetermined threshold target value; and
selectively controlling the flow control device based at least in part on whether the magnitude of the difference between the third velocity and the fourth velocity is greater than or equal to the second predetermined threshold target value.

28-30. (canceled)
